(19) United States
(12) Patent Application Publication
(10) Pub. No.: US 2008/0081772 A1
(43) Pub. Date: Apr. 3, 2008

(54) Mechanical Element

(75) Inventor: Ken Kawata, Ashigarakami-gun (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/864,324

(22) Filed: Sep. 28, 2007

(30) Foreign Application Priority Data
Sep. 29, 2006 (JP) 267520/2006

(51) Int. Cl. F16C 33/00

(52) U.S. Cl. 508/100

(57) ABSTRACT

A novel mechanical element is disclosed. The mechanical element comprises at least two surfaces movable at peripheral speeds differed from each other, and a lubricant composition disposed between said two surfaces, a surface of at least one said two surfaces having an organic residue having carboxyl group, sulfoxyl group, cyclic or non-cyclic carbamoyl group, cyclic or non-cyclic ureylene group, cyclic or non-cyclic sulfarnoyl group, or cyclic or non-cyclic amidino group, and said lubricant composition comprising a discotic compound having at least one tautomeric group represented by a formula (1) in which A is a ring in which from 5 to 7 atoms are embedded, wherein one of, or two or more of the ring-composing atoms may have a substituent, or may be condensed with other ring.

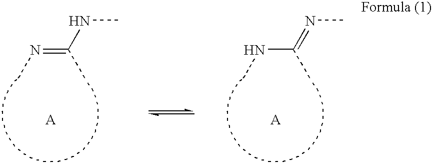

### CROSS-REFERENCE TO RELATED APPLICATIONS

This application claims benefit of priority under 35 U.S.C. 119 to Japanese Patent Application No. 2006-267520, filed Sep. 29, 2006, and the entire content of the application is incorporated herein by reference.

### BACKGROUND OF THE INVENTION

1. Field of the Invention

The present invention relates to a mechanical element comprising at least two surfaces movable at peripheral speeds differed from each other, and a lubricant composition disposed between the two surfaces.

2. Related Art

With enhanced spirit on preservation of the global environment in recent years, there have been growing demands on fuel saving of industrial machines and automobiles. Saving fuel needs improvement in viscosity characteristics of lubricating oils, and reduction in frictional resistance of driving units. This means improvement in viscosity which is a principal material factor in a fluid lubrication (hydrodynamic) process of a lubricating oil film, and improvement in materials such as oil material, extreme-pressure agents or frictional-control additives, which are principal material factors in a boundary lubrication process in which an interfacial lubrication film formed at the interface prevents the surfaces brought into direct contact from fusing, and lowers the frictional resistance. The latter technique of boundary lubrication film, however, suffers from a problem that all known materials capable of forming such current boundary lubrication film contain environmental-burden or environmental-toxic substances, so that the lubrication technology, which support the industry, is in need of urgent and drastic improvement on the global basis, under growing consciousness to environment as being demonstrated by successive enactment of laws such as ELV (End-of-Life Vehicles), WEEE (Waste Electrical and Electronic Equipment), and RoHS (Restriction of the use of certain Hazardous Substances in electrical and electronic equipment) in Europe.

Recently, discotic compounds having several radially-artanged side chains, exhibiting low friction under extreme pressures, has been proposed as an element of lubricant (Japanese Laid-Open Patent Publication Nos. 2002-69472, 2003-192677 and 2004-315703). It has also been reported that the viscosity-pressure coefficient α of these discotic compounds show small as well as animal and plant oils (Masanori HAMAGUCHI, Nobuyoshi OHNO, Kenji TATEISHI and Ken KAWATA, Proceedings of the International Tribology Conference, Tokyo, 2005-11, p. 175).

Absolutely different from the current technology of boundary lubrication film, this technology successfully ensures low function and anti-wearing property, by replacing low-viscosity lubricating oils, which are less likely to develop an elasto-hydrodynamic lubrication process under high pressures, with discotic compounds, so as to develop an elasto-hydrodynamic lubrication process even under extremely severe conditions which have otherwise been classified into the process of boundary lubrication in the conventional technology. The discotic compounds, capable of composing these elements without containing environmental-toxic substances, are also expected as high-perfommance and environment-friendly technology, substituting the current technology of boundary lubrication film. However, the discotic compounds, when used alone, have not successfully been obtained in a form of fluid showing low viscosity comparative to that of the current base oils, nor showing low viscosity under extremely low temperatures, whereas dissolution thereof into base oils makes it difficult to fully exhibit the low friction property and anti-wearing property. A technique of achieving an efficient segregation to the interface of sliding has therefore been expected.

### SUMMARY OF THE INVENTION

An object of the present invention is to provide a mechanical element showing an excellent anti-wearing property and low friction coefficient even under extreme pressures.

Another object of the present invention is to provide a mechanical element capable of being stably operated without using any lubricant containing environmental-burden or environinental-toxic substances.

In one aspect, the present invention provides a mechanical element comprising at least two surfaces movable at peripheral speeds differed from each other, and a lubricant composition disposed between said two surfaces, a surface of at least one said two surfaces having an organic residue having carboxyl group, sulfoxyl group, cyclic or non-cyclic carbamoyl group, cyclic or non-cyclic ureylene group, cyclic or non-cyclic sulfamoyl group, or cyclic or non-cyclic amidino group, and said lubricant composition comprising a discotic compound having at least one tautomeric group represented by a formula (1) below:

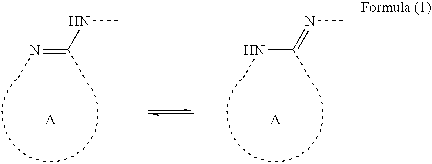

where, A is a ring in which from 5 to 7 atoms are embedded, wherein one of, or two or more of the ring-composing atoms may have a substituent, or may be condensed with other ring.

As embodiments of the invention, there are provided the mechanical element wherein the lubricant composition further comprises lubricating base oil; and the mechanical element wherein the lubricant composition comprises the discotic compound in an amount of from 0.1 to 30% with respect to the total mass.

The discotic compound may be selected from discotic compounds having at least three chain substituents each of which is five atoms or more bound to linearly.

The discotic compound may be selected from the compounds represented by a formula (2) below:

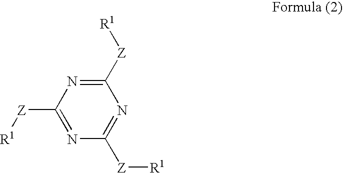

where, each of three Zs independently represents —O—, —S— or —NR— (R represents a hydrogen atom or C₁₀ or shorter alkyl group), provided that at least one of which represents —NH—; each of three R's independently represents a substituent, provided that at least two of which represent substituents each containing an aromatic ring group having a chain substituent which is five atoms or more bound to linearly.

The discotic compound may also be selected from polymers represented by a formula (3)-a, (3)-b or (4) below:

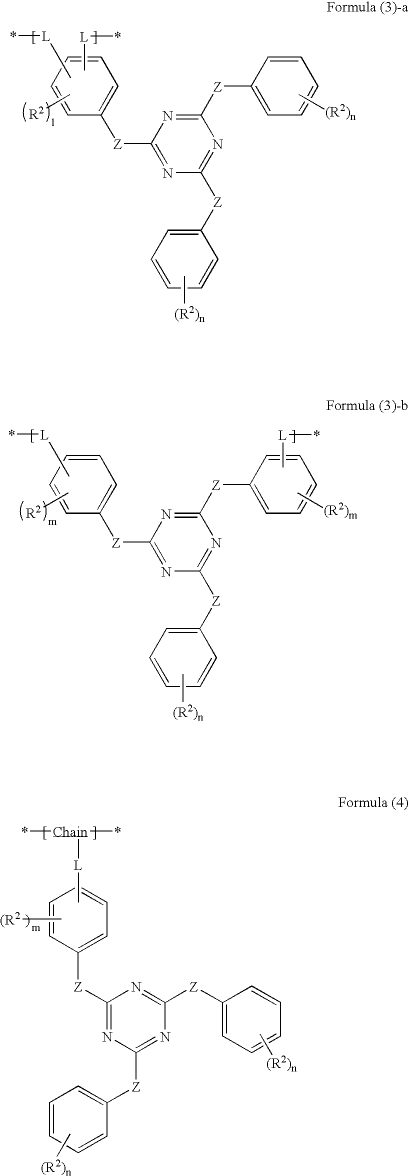

where, each of three Zs independently represents —O—, —S— or —NR— (R represents a hydrogen atom or C₁₀ or shorter alkyl group), provided that at least one of which represents —NH—; each of three R²s independently represents a substituent having 80 or smaller number of atoms therein; 1 represents an integer from 0 to 3, m represents an integer from 0 to 4 and n represents an integer from 0 to 5, a plurality of ms and ns in the formulae may be same or different, a plurality of R²s, for the case where 1, m and n are 2 or larger, may be same or different; each L independently represents a divalent linking group; and “Chain” represents a monomer-derived repeating unit composing the principal chain having at least L as a substituent.

In the formula (3)-a, formula (3)-b and formula (4), at least one of R²s may represent a substituent having an oligoalkyleneoxy chain, oligosiloxy chain or oligoperfluoroalkyleneoxy chain therein.

According to the present invention, it is possible to develop a low function property and maintain an anti-wearing property under extreme pressures by employing a lubricant composition comprising a discotic monomer or discotic polymer. According to an embodiment where a lubricant composition comprising a discotic monomer or a discotic polymer and base oil is employed, it is possible to improve an anti-wearing property and to reduce the friction coefficient under extreme pressures, which is ascribable to the discotic monomer or polymer segregated at the interface of sliding, and to obtain fluidity at low temperatures, and low friction at the start of operation or under low-load operation, which is ascribable to the base oil.

According to the invention, it is also possible to provide a mechanical element excellent also in the environmental friendliness, by employing a lubricant composition which requires no sulfur, chlorine, heavy metals and so forth as the essential elements.

### DETAILED DESCRIPTION OF THE INVENTION

Paragraphs below will detail the present invention. It is to be understood that the expression “to” in this specification means the range determined by numerals placed therebefore and thereafter, user for indicating the lower limit and the upper limit, respectively.

[Mechanical Element]

The present invention relates to a mechanical element comprising at least two surfaces movable at peripheral speeds differed from each other, and a lubricant composition disposed between the two surfaces. In this specification, the term “mechanical element” is used for any tribo-mechanical elements such as any slipping elements, any rolling elements, any conducting elements, and any sealing elements employed in any mechanical portions under sliding operation. Machines are characterized extremely simply as “moving matters”, and therefore most of them comprise tribological elements. When a machine starts to move, firstly, the machine is added with the inertial force thereby getting troubles such as destructions, vibrations/noises, and then, tribological elements thereof gets tribological troubles such as friction, wearing and leakage. Such destruction, vibration/noise, and tribological troubles are understood as big-3 troubles of machines. The present invention relates to a technology aimed at effectively preventing these troubles from generating, wherein examples of the mechanical element of the present invention include all of tribological elements possibly overcame these troubles by employing this technology. There is no special limitation on the peripheral speed of two surfaces. In one example of oil-impregnated sintered bearing, the peripheral speed may range from 0.01 to 10 m/sec or around, and the difference in the peripheral speeds between two surfaces may be in the same range. In one example of thrust bearing employed in a rotating machine, the peripheral speed may ranges from 10 to 120 m/sec or around, and the difference in the peripheral speeds between two surfaces may be in the same range.

[Two Surfaces Movable at Peripheral Speeds Differed from Each Other]

In the present invention, there are no special limitations on materials respectively composing two these surfaces. Two surfaces may be made of the same material, or different materials. The materials are exemplified by ceramics such as silicon carbide, silicon nitride, alumina and zirconia; cast iron; copper, copper-lead, aluminum alloys and their cast products; white metal; various plastics such as high-density polyethylene (HDPE), tetrafluoroethylene resin (PFPE), polyacetal (POM), polyphenylene sulfide (PPS), polyether ether ketone (PEEK), polyamidimide (PAI), and polyimide (PI); organic-inorganic hybrid materials combining plastics with glass, carbon, or aramid fiber; and hybrid materials of ceramic and metal such as cermet.

Besides the above-described resins and ceramic materials, also carbon steel for mechanical structures; alloy steels for structures and machines such as nickel-chromium steel, nickel-chromium-molybdenum steel, chromium steel, chromium-molybdenum steel, and aluminum-chromium-molybdenum steel; and materials having diamond-like carbon or other resin film coated on the surface of stainless steel, multi-aging steel or the like, are preferably used.

Still other examples include sintered metal having on the surface thereof a porous layer formed by sintering copper-base metal powder, and having a lubricant composition impregnated therein; porous ceramics typically formed based on strong binding of fine particles of calcium zirconate (CaZrO₃) and magnesia (MgO); porous glass obtained by thermally inducing phase separation between silica and borate-base component; sintered porous mold product of ultra-high-molecular-weight polyethylene powder; porous film made of fluorine-containing-resin such as tetrafluoroethylene; poly-sulfone-base porous film used for micro-filter and so forth; and porous film formed by preliminarily inducing phase separation between a poor solvent of a mold product and a monomer for forming the mold product during the polymerization.

Two these surfaces are disposed at a distance, holding a lubricant composition described later in between, and thereby configured as being movable at peripheral speeds differed from each other. Each of two these surfaces has an organic residue having a functional group, at the interface with the lubricant composition. The functional group is preferably carboxyl group, sulfoxyl group, cyclic or non-cyclic carbamoyl group, cyclic or non-cyclic ureylene group, cyclic or non-cyclic sulfamoyl group, or cyclic or non-cyclic amidino group. There are no special limitations on methods of introducing the organic residue having these functional groups. The simplest method may be such as covering the individual surfaces with a polymer film having the organic residue. This method is preferably adoptable for the surfaces composed of metals. Besides these, also techniques such as vacuum evaporation, sputtering and CVD may be used for forming the covering film.

The surfaces composed of ceramics may have the functional groups directly induced on the individual surfaces. For example, carboxyl group may be produced by oxidizing the surface composed of a carbon-base ceramic. It is also possible to produce a desired functional group by reductively introducing amino group to the surface composed of a nitrogen-containing ceramic, and then introducing carbamoyl group, ureido group, or sulfamoyl group. Carboxyl group may be produced also by oxidative treatment of the surfaces composed of diamond-like carbon.

The surfaces composed of resins may have the functional groups induced by chemical surface treatment. For example, the surfaces composed of a resin containing carbon, nitrogen and sulfur elements may readily be induced, by chemical surface treatment, with carboxyl group, cyclic or non-cyclic carbamoyl group, sulfoxyl group, cyclic or non-cyclic ureylene group, cyclic or non-cyclic sulfamoyl group, and cyclic or non-cyclic amidino group. It is also possible to locate desired organic residues on the surfaces by using a composition originally comprising a polymer having such functional group for producing the surfaces. The density of the desired functional group on the topmost surface may be increased by further adjusting conditions for molding after mixing and melting of the polymer, and by further processing the mold typically by cutting.

A desired functional group may be produced indirectly on the surfaces composed of ceramics or polymers by inducing hydroxyl group, amino group, mercapto group or the like on the surfaces, and then binding an organic residue having a desired functional group such as a carboxyl group, sulfoxyl group, cyclic or non-cyclic carbamoyl group, cyclic or non-cyclic ureylene group, cyclic or non-cyclic sulfamoyl group, and cyclic or non-cyclic amidino group, to the induced groups.

The methods of producing desired organic residues on the surfaces employing chemical bonds, as described above, are superior to the methods of covering the surfaces with a film made of a material having a desired organic residue, in terms of adhesiveness.

It is preferable that the functional group which locates at the interface with the lubricant composition can form a stable base pair with a tautomeric group of the discotic monomer or polymer in the lubricant composition described later. The organic residue having the functional group exhibiting such properties may be represented by the formula (5)-a, b, c, d, e or f below.

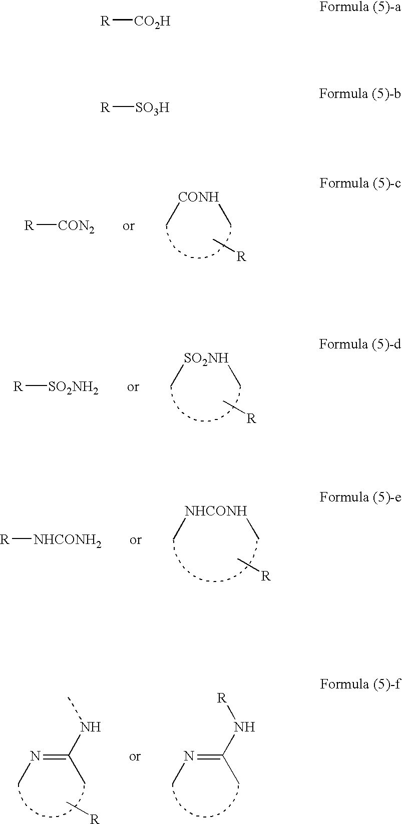

In the formulae (5)-a to f in the above, R is an expression for not only a linkage group coupling each functional group with a material composing the surfaces (or a material composing a film covering the surfaces), but also a material composing the surfaces (or a material composing a film covering the surfaces) coupled therewith. It is to be understood that the functional group and/or the linkage group may be a group of atoms originally included in the material composing the surfaces, or may be a group inherent to an agent for introducing the functional group introduced at the same time in the process of introducing the functional group.

Specific examples of the organic residues represented by the formulae (5)-a to f include, but are not limited to, those shown below. 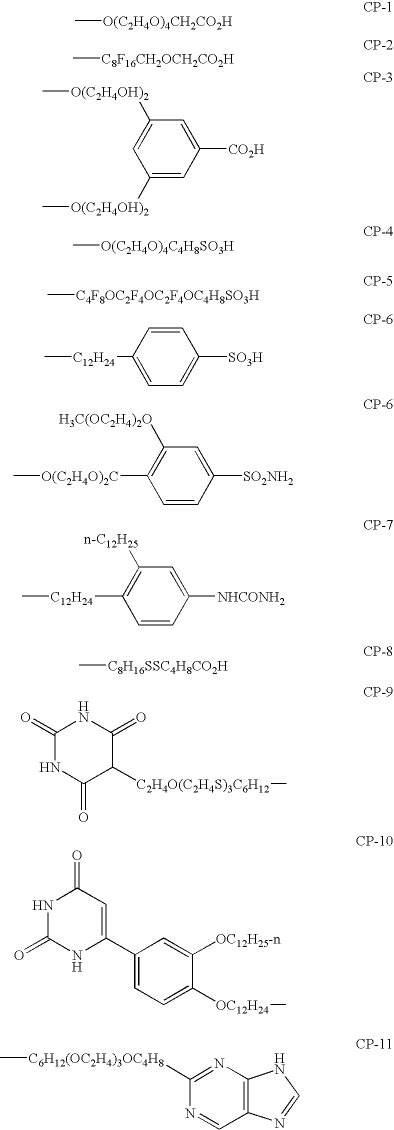
[Lubricant Composition]

The mechanical element of the present invention comprises a lubricant composition containing a discotic compound having an amidine-type tautomeric group represented by the formula (1) below.

[Discotic Compound]

The discotic compound has an amidine-type tautomeric group represented by the formula (1) below. The discotic compound may be a monomer having the tautomeric group, or may be a polymer (referred to as “discotic polymer”, hereinafter) containing a repeating unit having the tautomeric group.

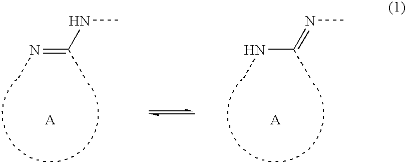

In the formula, “A” is a ring in which from 5 to 7 atoms are embedded, wherein, one of, or two or more of the ring-composing atoms may have substituent(s), or may be condensed with other ring(s). The ring A is generally an aromatic heterocycle, and is preferably a 5-membered or 6-membered, or a condensed ring of them with other aromatic ring(s) (e.g., benzene ring). Specific examples of the ring A include pyrrole ring, imidazole ring, oxazole ring, thiazole ring, pyrazole ring, triazole ring, pyridine ring, pyrimidine ring, pyridazine ring, triazine ring, tetrazine ring, dihydroazepine ring, and condensed rings of these rings with benzene.

Tautomerization will now be explained. A phenomenon of isomerization such that a certain compound can exist in forms of two isomers readily interconvertible therebetween, is called tautomerization, and each of the individual isomers is called tautomer. Many of changes between two tautomers are caused by changes in bond position of a hydrogen atom. A compound having a functional group capable of such tautomerization can form, through a hydrogen bond, a relatively stable complex structure together with other compound having similar tautomeric structures, such as the same amidine structure or keto-enol tautomers (carbamoyl group, carboxyl group). For example, the tautomeric group represented by the above-described formula (1) forms complex with amidino group, carbamoyl group and carboxyl group respectively as represented by the formulae (2) to (4) below.

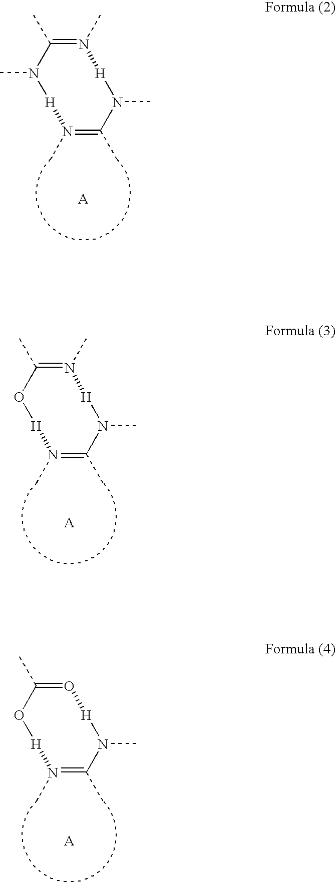

A typical example is a base pair formed, through hydrogen bonds, by a purine base and a pyrimidine base composing nucleic acids (DNA and RNA).

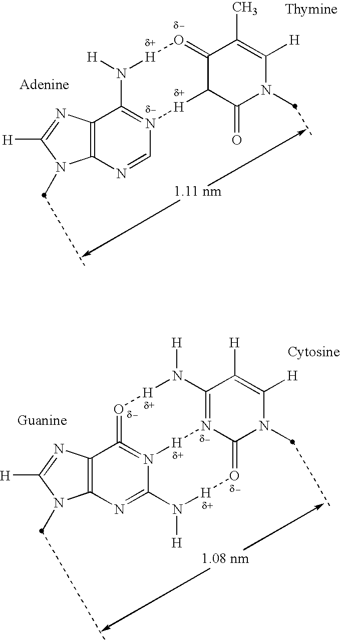

Normal pairs in DNA is a base pair between adenine (A) as a purine base and thymine (T) as a pyrimidine base, and a base pair between guanine (G) as a purine base and cytosine (C) as a pyrimidine base, wherein the former is stabilized by two hydrogen bonds, and the latter is stabilized by three hydrogen bonds. This sort of base pair is called a complementary base pair, forming the hydrogen bonds while keeping the planarity thereof, so that planar discotic compounds are expected to ensure a wide range of planarity in a supermolecular manner.

The lubricant composition used in the present invention contains a compound having the discotic structure as a partial structure thereof, wherein in this specification, the “discotic compound” means a compound having a discotic structure at least as a partial structure thereof, without needing that the structure of the whole molecule is discotic. The structural feature of the discotic segment can be explained with an original form thereof, namely a hydrogenised compound, as an example, as follows:

A molecular size of a hydrogenised compound, which can be an original form of a discotic compound, may be obtained by 1) to 5) steps.

1) To create a possible planar, desirably an exact planar, molecule structure for a target molecule. For creating, standard bond-length and bond-angle values based on orbital hybridization are desirably used, and such standard values can be obtained with reference to the 15th chapter in the second volume of “Chemical Handbook, revised version 4, Foundation Section (Kagaku Binran Kaitei 4 Kisohen)” compiled by The Chemical Society of Japan, published by MARUZEN in 1993.

2) To optimize a molecular structure using the above-obtained planar structure as a default by molecular orbital method or molecular mechanics method. Examples of such methods include Gaussian92, MOPAC93, CHARMm/QUANTA and MM3, and Gaussian92 is desirably selected.

3) To move a centroid of the optimized structure to an origin position and to create a coordinate having an axis equal to a principal axis of inertia (a principal axis of a inertia tensor ellipsoid).

4) To set a sphere defined by van der Waals radius in each atom positions thereby drawing a molecular structure.

5) To calculate lengths along to three coordinate axes on van der Waals surface thereby obtaining “a”, “b” and “c”.

Using “a”, “b” and “c” obtained trough the steps 1) to 5), “a discotic structure” can be defined as a structure which satisfies a≧b>c and a≧b≧a/2, and a preferred example of the discotic structure is a structure which satisfying a≧b>c and a≧b≧0.7 a or b/2>c.

Examples of the compound, which can be an original form of a discotic compound, include mother cores and derivatives described in various literatures such as “Ekisho no Kagaku (Science of Liquid Crystal), edited by the Chemical Society of Japan, Seasonal Chemical Review No. 22, Chapter 5, and Chapter 10, Section 2 (1994); C. Destrade et al., Mol. Crysr. Liq. Cryst., vol. 71, p. 111 (1981); B. Kohne et al., Angew. Chem. Vol. 96, p. 70; compounds described in J. M. Lehn et al., J. Chem. Soc. Chem. Commun., p. 1794 (1985); and J. Zhang et al., J. Am. Chem. Soc., vol. 116, p. 2655 (1994). More specific examples of the hydrogenated compound include benzene derivatives, tri phenylene derivatives, truxene derivatives, phthalocyanine derivatives, porphyrin derivatives, anthracene derivatives hexaethynylbenzene derivatives, dibenzopyrene derivatives, coronene derivatives and phenylacetylene macrocycl derivatives. The examples also include cyclic compounds described in “Chemical Review (Kagaku Sousetsu) No. 15 Chemistry of Novel Aromatic Series (Atarashii Houkouzoku no Kagaku)” compiled by the Chemical Society of Japan, published by University of Tokyo Press in 1977; and electronic structures such as heteroatom-substituted compounds thereof. As well as the above mentioned metal complexes, examples of the discotic core include hydrogen-bonded or coordination-bonded plural molecules to form a discotic aggregate. Examples of the discotic compound include any compounds having such a discotic mother core at a central portion thereof, and radially substituting groups of the core, such as a liner alkyl and alkoxy group and substituted benzoyl oxy group as a side chain. Examples of the ring A in the formula (1) include any ring structures which has a carbon atom embedded therein replaceable with a nitrogen atom and the adjacent carbon thereto having a hydrogen atom replaceable with —NH-(imino).

Specific examples of the tautomeric group represented by the above-described formula (1) include, but are not limited to, those shown below.

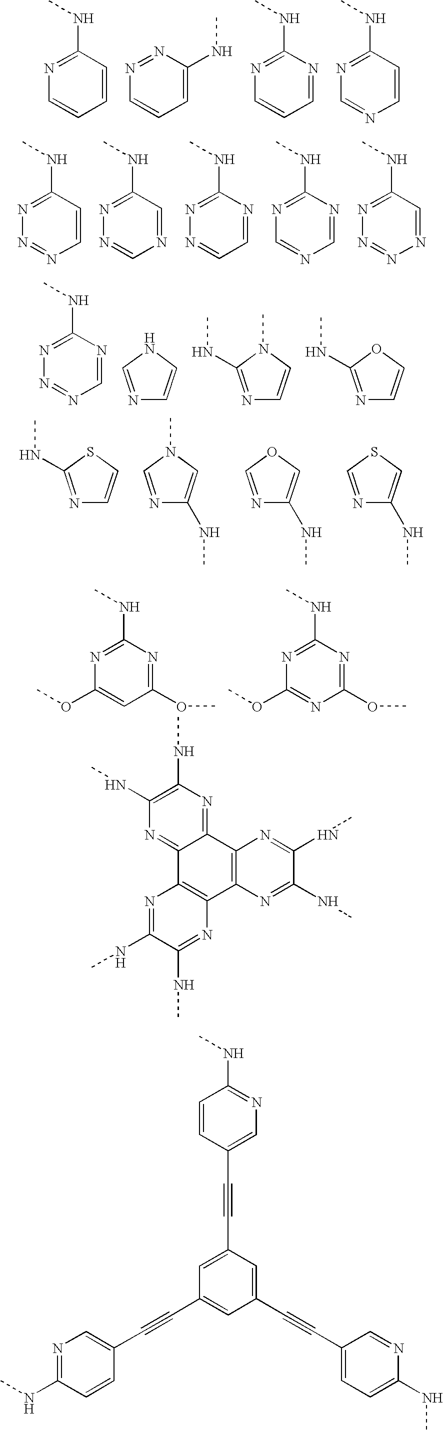

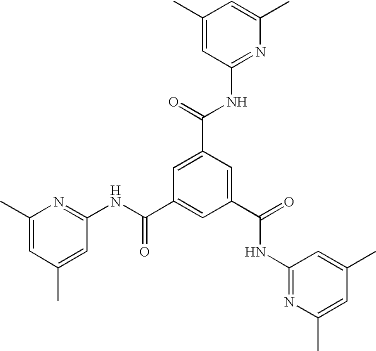

The tautomeric group represented by the above-described formula (1) may be a central core of the discotic compound, or may be a part of side chain(s) radially extended from the central core. According to an embodiment wherein the discotic compound is a 5 polymer comprising a repeating unit(s) having a tautomeric group represented by the formula (1) as described in the above, the tautomeric group may be a part of the principal chain of the polymer, or may be a part of the side chain(s) binding to the principal chain of the polymer.

The discotic compound preferably has at least 3 chain substituents, together with the tautomeric group. The chain substituents preferably bind to sites of a ring composing the discotic core included in the discotic compound, preferably in a radial manner. For an embodiment wherein the ring composing the discotic core is a 6-membered ring, the chain substituents preferably binds to atoms at the 1-position, 3-position and 5-position. For an embodiment wherein the ring composing the discotic structure is 1,3,5-triazine ring, the chain substituents preferably bind to carbon atoms at the 2-, 4-, and 6-positions. For an embodiment wherein the tautomeric group represented by the formula (1) is a ring composing the discotic core, the chain substituents may bind to ring-composing atoms or to NH— in the formula, directly or through linking groups.

The chain substituent is preferably a chain substituent which is five 5 or more atoms bound to linearly (e.g., alkyl groups typically exemplified by C₅ or longer normal alkyl group, alkoxy groups typically exemplified by those containing C₄ or longer normal alkyl chain). The chain substituent is typically exemplified by alkyl group, alkoxy group, aryloxy group, alkoxycarbonyl group, alkylthio group, arylthio group, alkylimino group, arylimino group, and acyloxy group. The chain substituent may contain a cyclic group such as aryl group or hetero ring group, so far as it has the chain structural portion having 5 or more atoms bound to linearly. Examples of the substituent include the substituents described in C. Hansch, A. Leo and R. W. Taft, Chem. Rev., 1991, Vol. 91, p. 165-195 (American Chemical Society); and the representative examples include alkoxy group, alkyl group, alkoxycarbonyl group, and halogen atom. The chain substituent may further contain functional groups such as ether group, ester group, carbonyl group, cyano group, thioether group, sulfoxide group, sulfonyl group, and amido group.

For further details, specific examples of the chain substituent include alkanoyloxy groups (e.g., hexanoyloxy, heptanoyloxy, octanoyloxy, nonanoyloxy, decanoyloxy, and undecanoyloxy groups), alkylsulfonyl groups (e.g., hexylsulfonyl, heptylsulfonyl, octylsulfonyl, nonylsulfonyl, decylsulfonyl, and undecylsulfonyl groups), alkylthio groups (e.g., hexylthio, heptylthio, and dodecylthio groups), arylthio groups (e.g., 3,4-dialkoxy-substituted phenylthio group, wherein alkoxy group is any of those exemplified for the alkoxy group described in the above), alkoxy groups (e.g., butoxy, pentyloxy, hexyloxy, heptyloxy, octyloxy, nonyloxy, decyloxy, undecyloxy, methoxyethoxy, ethoxyethoxy, methoxydiethyleneoxy, triethyleneoxy, and hexyloxydiethyleneoxy groups), aryloxy groups (e.g., 3,4-dialkoxy-substituted phenyloxy group, wherein alkoxy group is any one of those exemplified for the alkoxy group described in the above), alkylamino groups (e.g., butylamino, pentylamino, hexylamino, heptylamino, octylamino, nonylamino, decylamino, undecylamino, methoxyethylamino, ethoxyethylamino, methoxydiethyleneamino, triethyleneamino, and hexyloxydiethyleneamino groups), arylamino groups (e.g., 3,4-dialkoxy-substituted phenylamino group, wherein alkoxy group is any one of those exemplified for the alkoxy group described in the above), 2-(4-alkylphenyl)ethynyl groups (alkyl group is typically any of methyl, ethyl, propyl, butyl, pentyl, hexyl, heptyl, octyl, and nonyl), 2-(4-alkoxyphenyl)ethynyl groups (alkoxy group is typically any one of those exemplified for the alkoxy group described in the above), terminal vinyloxy groups (e.g., 7-vinylheptyloxy, 8-vinyloctyloxy, 9-vinylnonyloxy groups), 4-alkoxyphenyl groups (alkoxy group is typically any one of those exemplified for the alkoxy group described in the above), alkoxymethyl groups (alkoxy group is typically any one of those exemplified for the alkoxy group described in the above), alkylthiomethyl groups (alkylthio group is typically any of those exemplified for the alkylthio group described in the above), 2-alkylthiomethyl groups (alkylthio group is typically any of those exemplified for the alkylthio group described in the above), 2-alkylthioethoxymethyl groups (alkylthio group is typically any of those exemplified for the alkylthio group described in the above), 2-alkoxyethoxyethyl groups (alkoxy group is typically any one of those exemplified for the alkoxy group described in the above), 2-alkoxycarbonylethyl groups (alkoxy group is typically any one of those exemplified for the alkoxy group described in the above), cholesteryloxycarbonyl, β-sitosteryloxycarbonyl, and 4-alkoxyphenoxycarbonyl groups (alkoxy group is typically any of those exemplified for the alkoxy group described in the above), 4-alkoxybenzoyloxy group (e.g., alkoxy group is any one of those exemplified for the alkoxy group described in the above), 4-alkylbenzoyloxy groups (alkoxy group is typically any of those exemplified for the 2-(4-alkylphenyl)ethynyl group described in the above), 4-alkoxybenzoyl groups (alkoxy group is typically any of those exemplified for the alkoxy group described in the above), perfluoroalkyl groups (alkyl group is typically any of those exemplified for the alkyl group described in the above), and polysiloxane groups.

Of those described in the above, the phenyl group may be replaced with any other aryl groups (e.g., naphthyl group, phenanthryl group, and anthracene group), or may further be substituted in addition to the above-described substituents. The phenyl group may also be any of heteroaromatic rings (e.g., pyridyl group, pyrimidyl group, triazinyl group, thienyl group, furyl group, pyrrolyl group, pyrazolyl group, imidazolyl group, triazolyl group, thiazolyl group, imidazolyl group, oxazolyl group, thiadialyl group, oxadiazolyl group, quinolyl group, and isoquinolyl group).

The number of carbon atoms contained in a single chain substituent is preferably 1 to 30, and more preferably 1 to 20.

In terms of that the discotic compound can form a complementary base pair with the functional groups such as carboxyl groups which reside on the individual planes, the imino group in the tautomeric group preferably has a relatively small pKa. For reducing pKa of the imino group, the ring A is preferably electron deficient ring, or preferably electron attractive ring in which larger electronegativity atom(s) is embedded. It can be therefore generally said that triazine ring is more preferable than pyridine ring if other substituents are same.

The discotic compound is preferably selected from 1,3,5-trisubstituted triazine compounds represented by the formula (2) below:

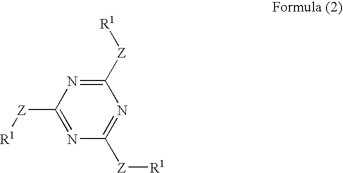

In the formula, each of three Zs independently represents —O—, —S— or —NR— (R represents hydrogen atom or C₁₀ or shorter alkyl group), and at least one of which represents —NH—. Each of three R¹s independently represents a substituent, wherein each of at least two of which represents a substituent containing an aromatic ring group having 5 or more atoms bound to linearly therein.

Examples of the chain substituent include alkyl groups (e.g., butyl, hexyl, octyl, and lauryl groups), substituted alkyl groups (e.g., 2-ethylhexyl, 3-hexyldecyl, methoxyethoxyethyl, ethyliminoethyliminoethyl, ethylthioethyl and butoxycarbonylethyl, cyclohexylcarbamoylmethyl, morpholinoethyl, N,N-dimethylaminoethyl, vinyloxypropyl, and propargyloxyethyl groups), perfluoroalkyl groups (e.g., perfluorobutyl, and perfluoroether groups), and polysiloxy group.

Examples of the aromatic ring having the chain substituent therein include those having a six-membered ring structure such as benzene ring and cyclohexane ring; those having ring structures directly binding to each other such as biphenyl, terphenyl and so forth; those having ring structures binding to each other through a linking group such as tolane and hexaphenylethynylbenzene; condensed rings such as naphthalene, quinoline, anthracene, triphenylene and pyrene; hetero rings in which heteroatom(s) such as nitrogen, oxygen and sulfur atom is embedded, such as furan, thiophen, pyrrole, oxazole, thiazole, imidazole, triazole, tetrazole, and benzene condensed ring thereof, pyridine, pyrimidine, pyrazine and quinoline.

Examples of the chain substituent composed of at least five atoms bound to linearly include those exemplified above.

The discotic compound is also preferably selected from polymers represented by the formula (3)-a, (3)-b or (4) below:

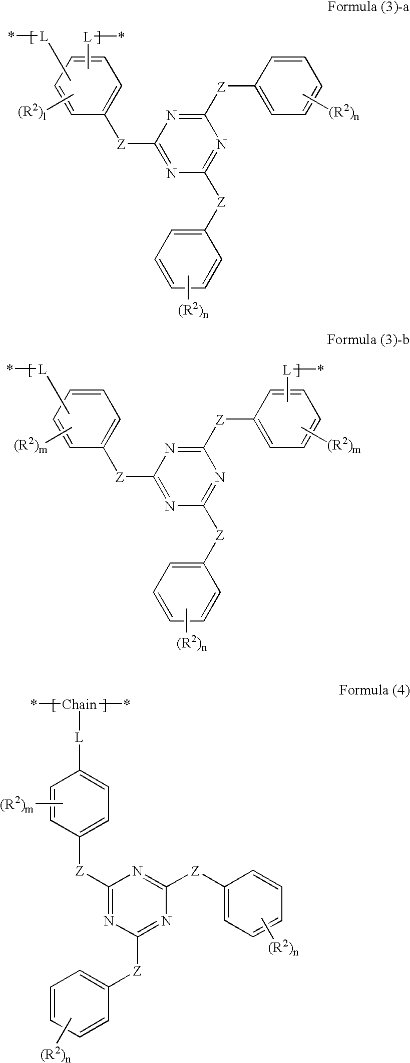

In the formulae, each of three Zs independently represents —O—, —S— or —NR— (R represents a hydrogen atom or C₁₀ or shorter alkyl group), provided that at least one of which represents —NH—; each of three R²s independently represents a substituent having from 1 to 80 number of carbon atoms, 1 represents an integer from 0 to 3, m represents an integer from 0 to 4 and n represents an integer from 0 to 5, a plurality of ms and ns in the formulae may be same or different, a plurality of R²s, for the case where l, m and n are 2 or larger, may be same or different, each L independently represents a divalent linking group, and “Chain” represents a monomer-derived repeating unit composing the principal chain having at least L as a substituent.

The linking group L and “Chain” are substituents binding to the sites of the ring composing the discotic structure, and examples of the substituent include alkylene groups, perfluoroalkylene groups, alkenylene groups, alkynylene groups, phenylene groups, polysiloxane groups and divalent linking groups based on combinations of these groups. They may further be combined with each other through a divalent linking group such as oxy group, carbonyl group, ethynylene group, azo group, imino group, thioether group, sulfonyl group and any combinations thereof such as a disulfide group, ester group, amido group and sulfonamido group. The “Chain” in the principal chain may have a substituent; and examples of the substituent include alkyl groups, cycloalkyl groups, aromatic ring groups such as phenyl group, heterocyclic group, halogen atom, cyano group, alkylamino group, alkoxy group, hydroxy group, amino group, thio group, sulfo group and carboxyl group.

In the formula shown in the above, the linking group L may be selected from divalent linking groups; and examples of the divalent linking group include an oxy group, carbonyl group, ethynylene group, azo group, imino group, thioether group, sulfonyl group and any combinations thereof such as a disulfide group, ester group, amido group, and sulfonamido group.

In the formula in the above, the substituent independently represented by each of three R²s may be the chain substituent described in the above, allowing a similar range of preferable examples. Also the linking group L and “Chain” may be the chain substituents described in the above, allowing similar ranges of preferable examples.

R² is a substituent of which the total number of atoms (including hydrogen atoms) is from 1 to 80. The total number of atoms (not including hydrogen atoms) in the longest chain of R² is preferably equal to or less than 35.

When R² is a substituent having a long alkyl chain therein, the number of atoms in R² is preferably from 25 to 75, and more preferably from 38 to 75.

When R² is a substituent having an oligoalkyleneoxy chain, oligosiloxy chain or oligoperfluoroalkyleneoxy chain therein, the number of atoms in R² is preferably from 10 to 55, and more preferably from 20 to 50.

The discotic compound, whether it might be a monomer or a polymer, having lower viscosity can more effectively suppress friction coefficient under low to middle load operation of typically from 5 MPa to 90 MPa. For this purpose, R¹, R², L or Chain preferably has an ether bond(s) therein. At least one of R¹, R² and 1, in the compound is preferably oligoalkyleneoxy chain, oligosiloxy chain or oligoperfluoroalkyleneoxy chain having an ether bond(s) therein.

The discotic compound may be a monomer or a polymer, anyway use of the lubricant composition comprising the discotic polymer is more likely to show relatively preferable lubrication characteristics, such as low friction and desirable anti-wearing property, even when there is only a small density of the organic residue at the interface.

Specific examples of the discotic compound, which can be used in the present invention, include, but are not limited to, those shown below. 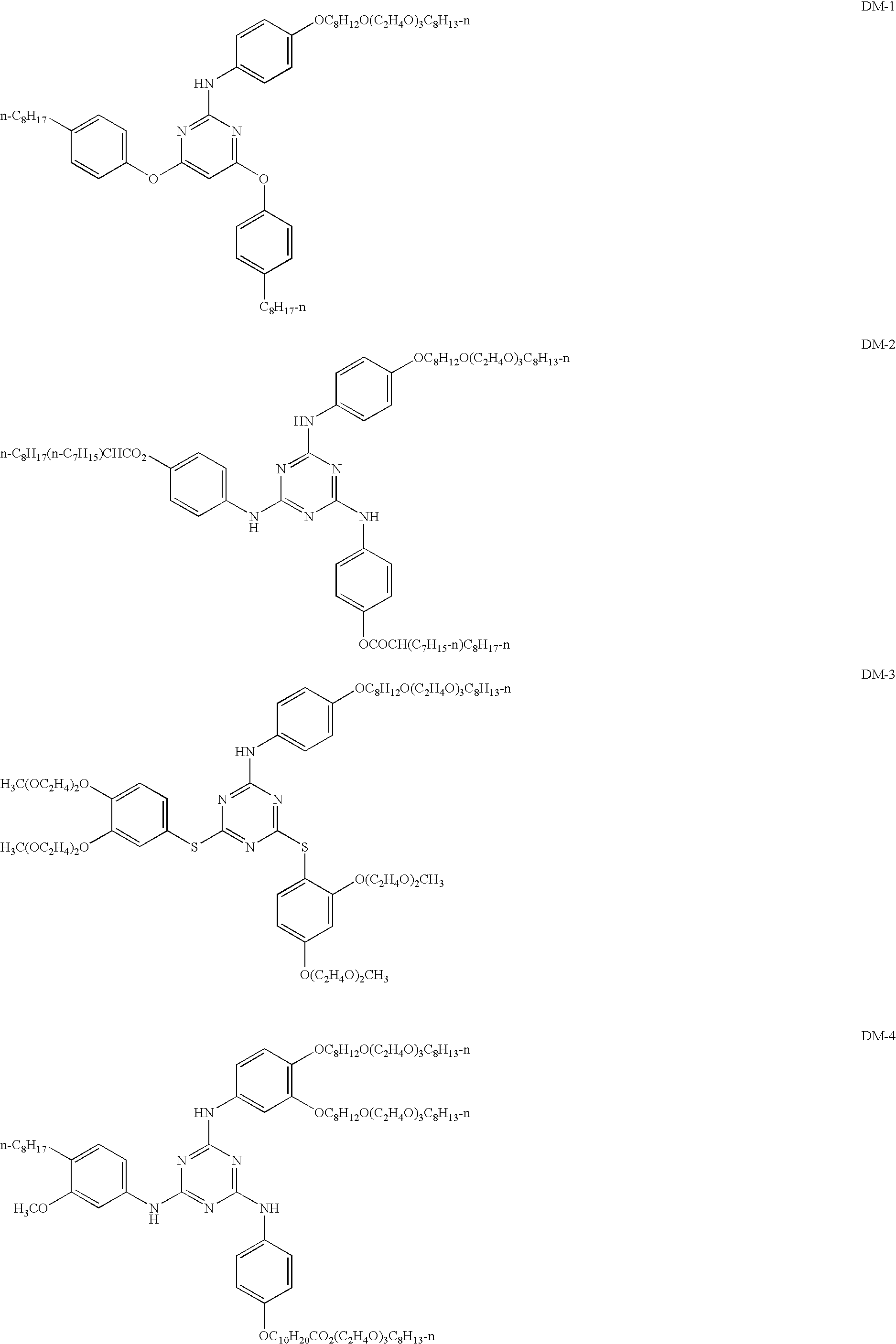 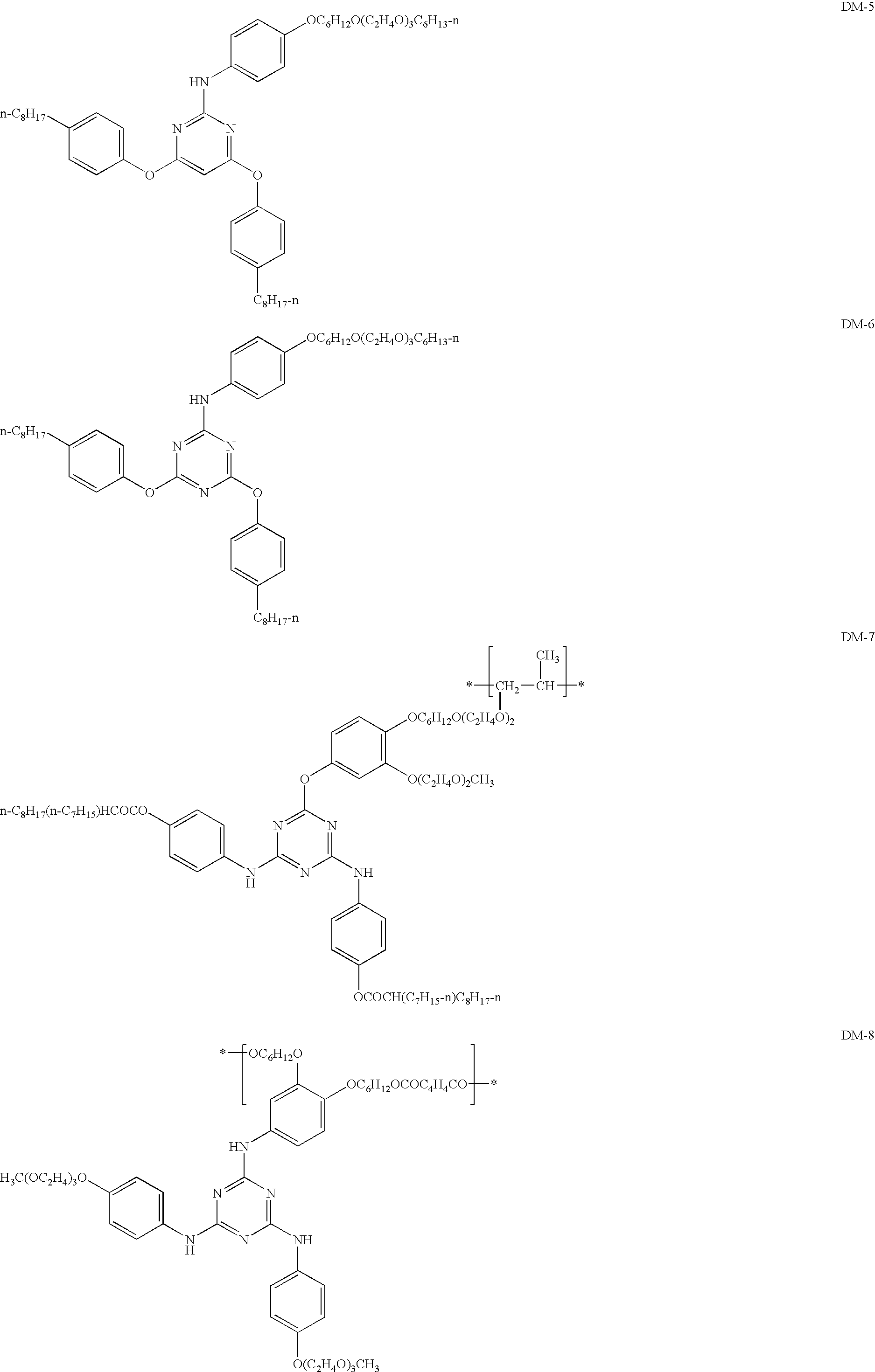 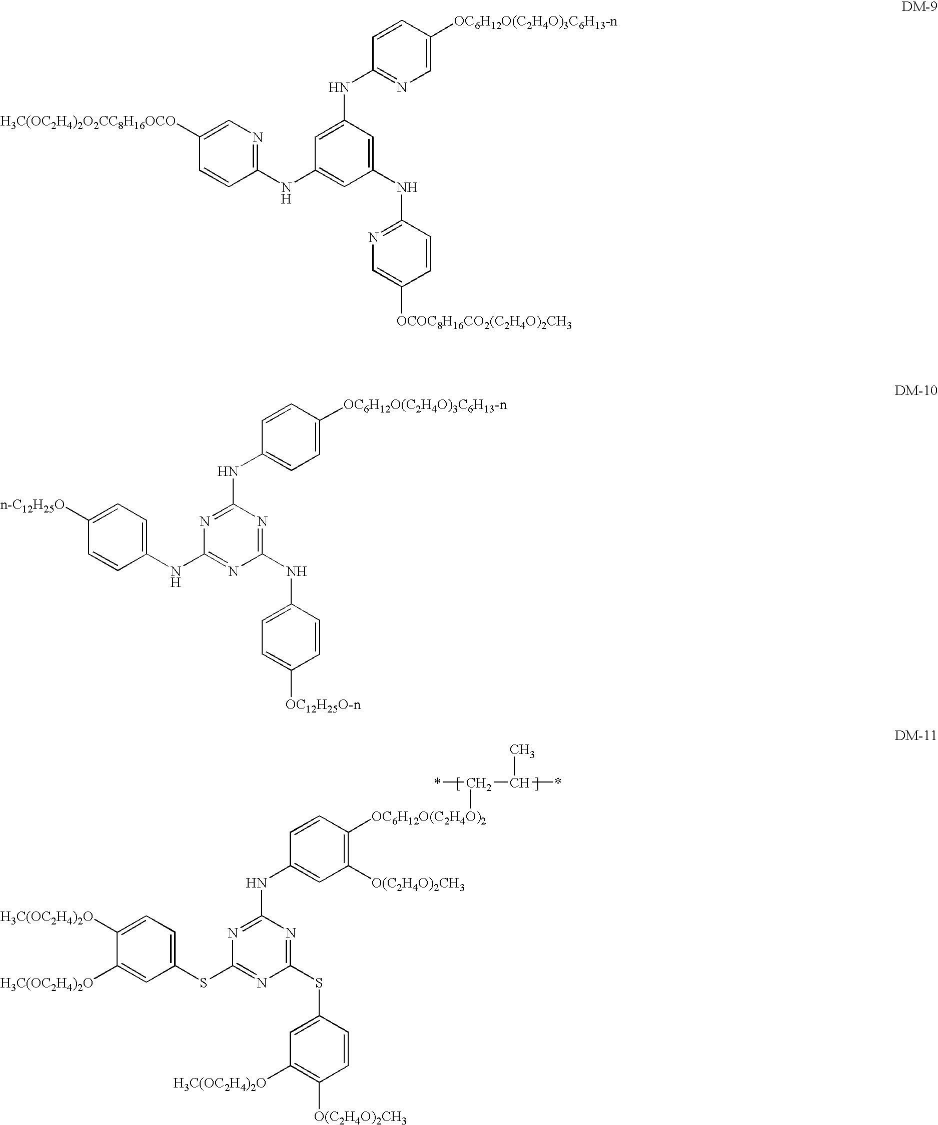 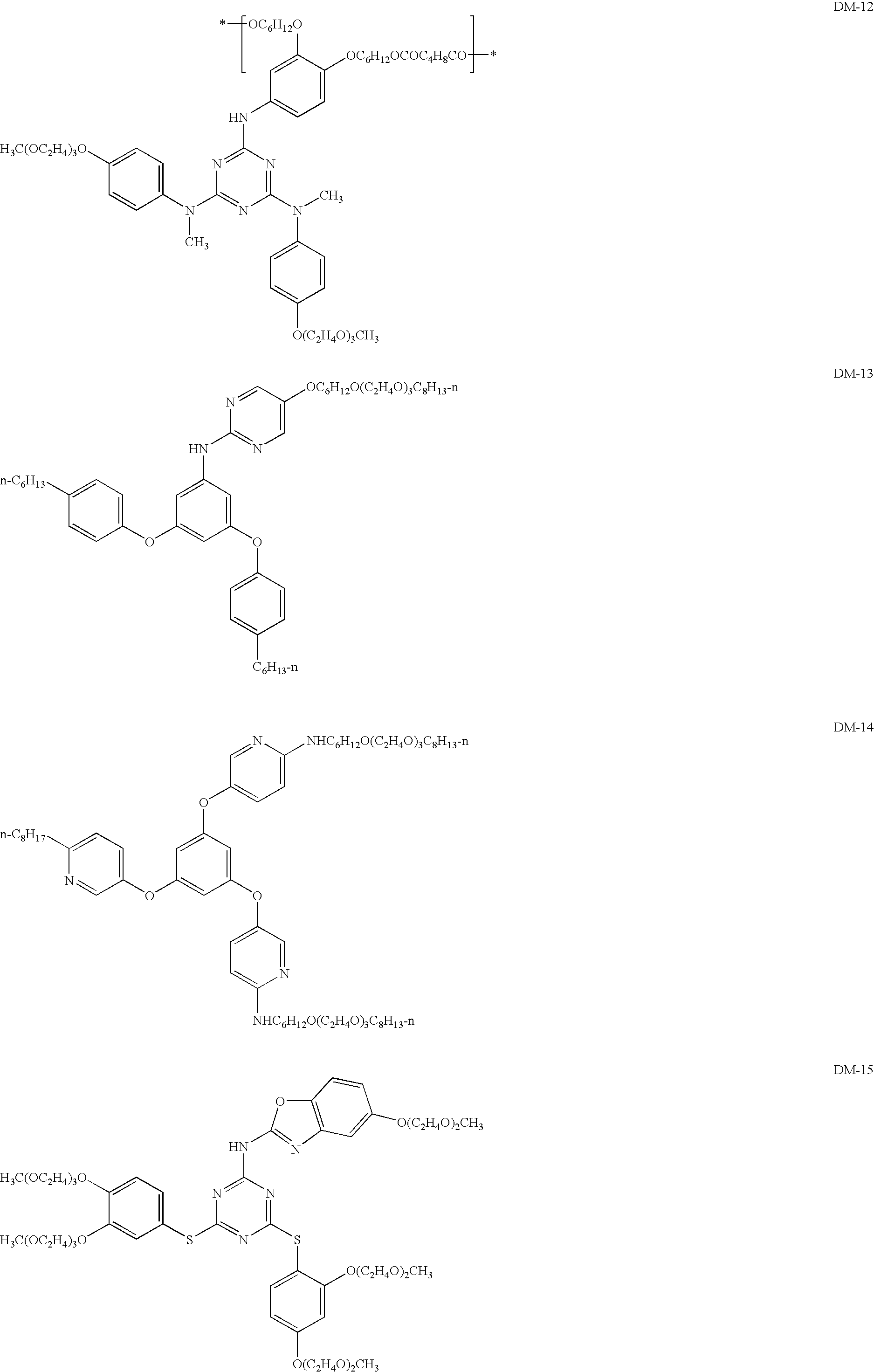 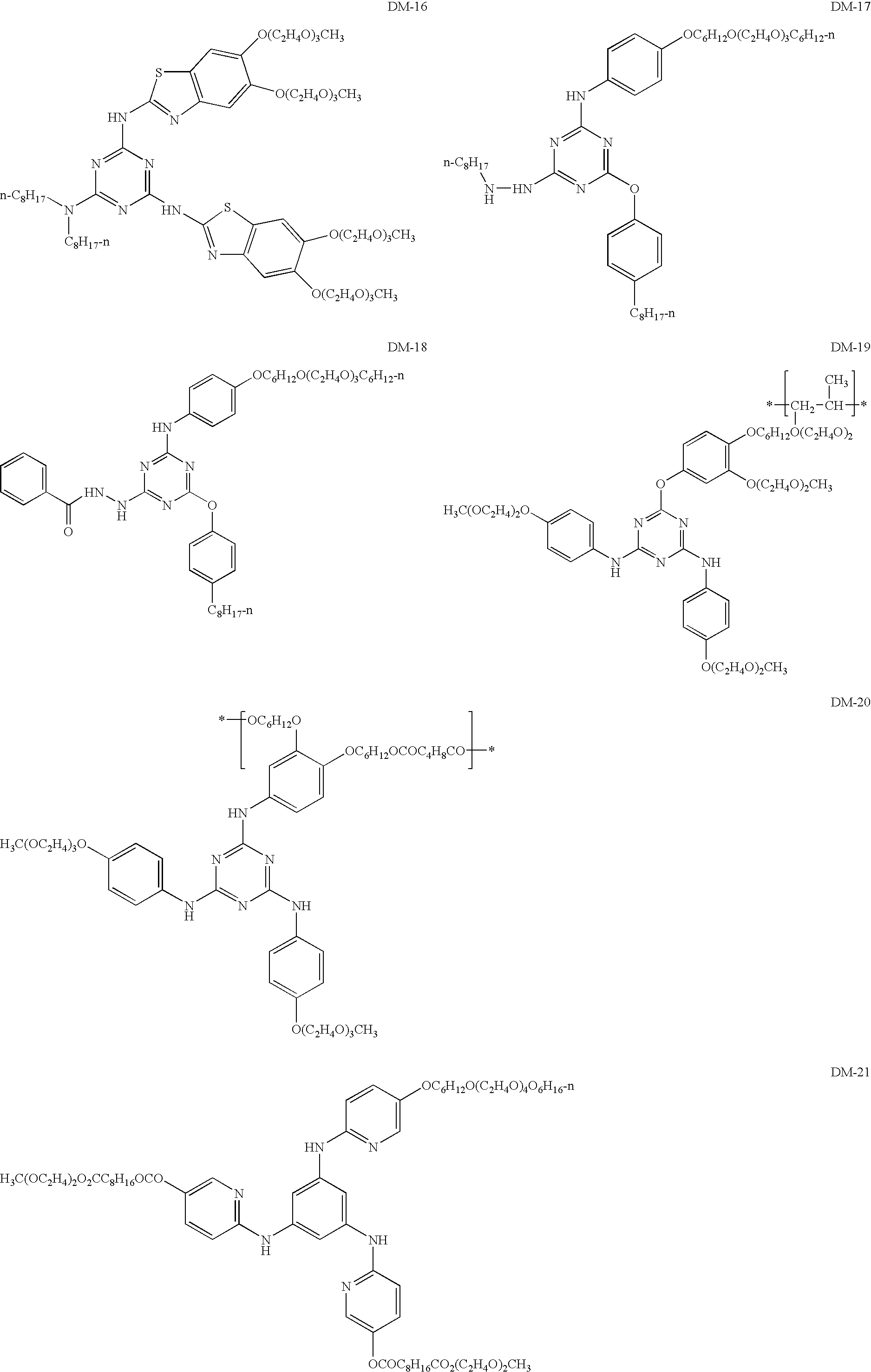 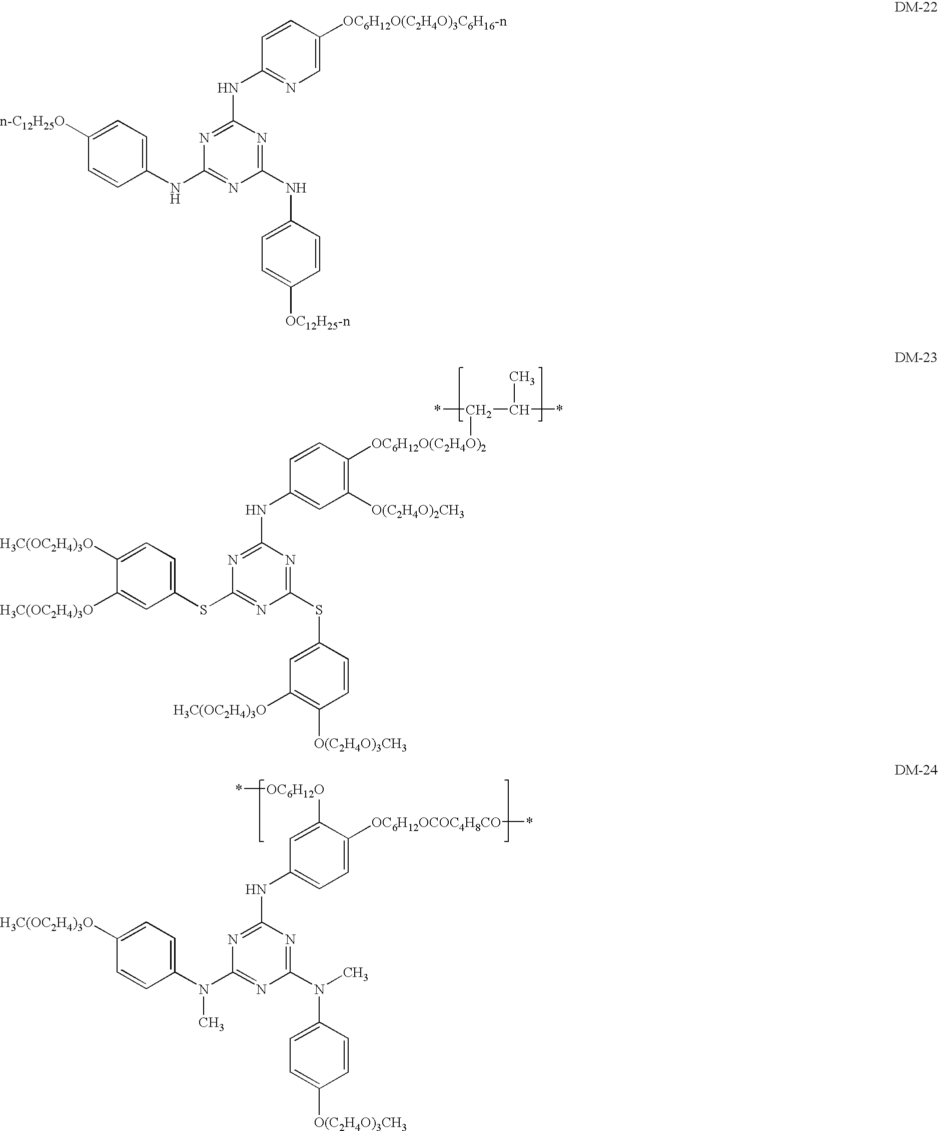
[Base Oil]

The lubricant composition may comprise base oil together with the discotic compound. Oily materials, which can be employed as base oil, may be one species, or two or more species selected from general mineral oils and synthetic oils having been used for base oil of conventional lubricating oil composition. For example, any of mineral oil, synthetic oil, or mixed oil of them may be used. The mineral oil is exemplified by solvent-purified raffinate obtained by extracting raw material of lubricating oil derived by distillation under normal pressure or reduced pressure of paraffin-base, intermediate-base or naphthene-base crude oil using an aromatic extraction solvent such as phenol, furfural or N-methylpyrrolidone; hydrogen-treated oil obtained by bringing raw material of lubricating oil into contact with hydrogen, under the presence of a hydrogen treatment catalyst such as cobalt or molybdenum held by silica-alumina; hydrocracked oil obtained by bringing the raw material into contact with hydrogen, under the presence of a hydrocracking catalyst under severe conditions for cracking; isomerized oil obtained by bringing wax into contact with hydrogen, under the presence of an isomerization catalyst under conditions for isomerization; and distillation fi-action of lubricating oil obtained by combinations of solvent purification process with hydrogen treatment process, hydrocracking process, isomerization process and so forth. In particular, high-viscosity-index mineral oil obtained by the hydrocracking process or isomerization process may be exemplified as a preferable product. In any method of the manufacturing, processes such as dewaxing, hydrofinishing, clay treatment process and so forth may arbitrarily be selectable according to general procedures. Specific examples of mineral oil include light neutral oil, medium neutral oil, heavy neutral oil, bright stock and so forth, wherein the base oil may be prepared by arbitrary mixing these oils so as to satisfy desired performances. The synthetic oil may be exemplified by poly(α-olefin), α-olefin oligomer, polybutene, alkylbenzene, polyol ester, dibasic acid ester, polyoxyalkylene glycol, polyoxyalkylene glycol ether, silicone oil and so forth. These base oils may be used independently, or in combination of two or more species thereof. It is also allowable to use the mineral oil and the synthetic oil.

The lubricating oil composition preferably contains 0.01 to 30 parts by mass of the discotic compound in a dissolved state, and 99.99 to 70 parts by mass of the oily substance, and more preferably contains 5 to 20 parts by mass of the discotic compound and 95 to 80 parts by mass of the oily substance. The content of the discotic compound within the above-described ranges is preferable in terms of fuel-saving property and low friction over a wide output range, improving the viscosity index, and developing a shearing stability over a wide output range. In an embodiment wherein the lubricant composition contains no base oil, the content of the discotic compound is preferably 50% or more of the total mass of the lubricant composition.

[Additives]

For the purpose of ensuring practical performances adapted to various applications, the lubricant composition may appropriately be added with lubricant and various additives used for bearing oil, gear oil and transmission oil, such as anti-wearing agent, extreme pressure agent, antioxidant, viscosity index enhancer, detergent-dispersant, metal deactivator, anti-corrosion agent, rust preventives, and defoaming agent, if necessary, so far as effects of the present invention will not be impaired.

[Applications]

The lubricant composition may be used as a lubricant for various mechanical elements. For example, engine oils for vehicles including automobiles, gear oil, hydraulic oil for automobiles, lubricating oil for marine vessels/aircrafts, machine oil, turbine oil, bearing oil, hydraulic fluid, oil for compressor/vacuum pump, freezer oil and lubricating oil for metal working, lubricant for magnetic recording media, lubricant for micro-machines, and lubricant for artificial bone.

### EXAMPLES

Paragraphs below will further specifically explain the present invention referring to Examples and Comparative Examples, without limiting the present invention. The lubricant compositions in Examples and Comparative Examples were evaluated according to the methods described below.

1. Methods of Evaluation and Measurement of Friction Coefficient by Reciprocating (SRV) Friction/Wear Test

Friction coefficient and anti-wearing property were evaluated by friction/wear test using a reciprocating (SRV) friction/wear tester, under the conditions below.

Mean friction coefficient and depth of wear were measured by applying 100 mg of sample lubricating oil on the surface of a plate described below, bringing the curved surface of a cylinder into contact with the sample so as to keep the lubricating oil in between, and moving the cylinder under load reciprocally in the direction normal to the longitudinal axis thereof.

[Test Conditions]

<<Geometry of Test Piece (Frictional Member)>>

Plates: 24 mm in diameter×7 mm

Plate A

material: SUJ-2 steel

surface roughness: 0.45 to 0.65 μm

Plate B

material: SUJ-2 steel+surface treatment B

surface roughness: 0.45 to 0.65 μm

surface treatment B: Plate A was immersed in a thioglycolic acid solution for 10 minutes, the surface was cleaned with methanol, and dried.

Plate C

material: SUJ-2 steel+DLC film (10 nm thick)

surface roughness: 0.02 μm

DLC film: diamond-like carbon film
(the same will apply, hereinafter)
   Plate D

material: SUJ-2 steel+DLC film (100 nm thick)+surface treatment D

surface roughness: 0.02 μm

surface treatment D: Plate C was irradiated for 10 minutes with plasma in an oxygen-containing argon atmosphere so as to modify the surface with carboxyl groups.

plate E

material: SUJ-2 steel+DLC film (10 nm thick)+surface treatment E

surface roughness: 0.02 μm

surface treatment E: Plate C was irradiated for 10 minutes with plasma in an ammonia gas atmosphere so as to modify the surface with amino groups, immersed in a solution containing compound T-1 shown below for 30 minutes, and the surface was cleaned with acetone and ethanol. 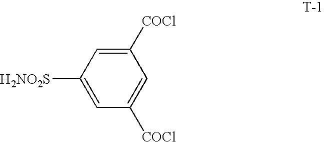
Plate F

material: SUJ-2 steel+DLC film (10 nm thick)+surface treatment F

surface roughness: 0.02 μm

surface treatment F: Plate C was irradiated for 10 minutes with plasma in an ammonia gas atmosphere so as to modify the surface with amino groups, immersed in a solution containing compound T-2 shown below for 30 minutes, and the surface was cleaned with acetone and ethanol.

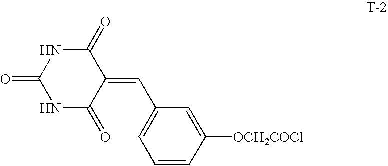

Cylinder: 15 mm in diameter×22 mm

material: SUJ-2 steel

surface roughness: 0.45 to 0.65 μm

Temperature: 80° C.

Load: 400 N (289 MPa)

Amplitude: 1.5 mm

Frequency: 50 Hz

Test time: 20 minutes (after 10 minutes of initial sliding at 50 N)

2. Frictional Behaviors of Lubricant Composition Containing Compound Having Discotic Structure

Using DM-2 as the compound having the discotic structure, and Mineral Super Oil N-32 from Nippon Oil Corporation as base oil, a lubricant composition was prepared as a 3% solution of DM-2. Lubricating performance of the lubricant composition was evaluated by the reciprocating (SRV) friction/wear test using the above-described plates A to F. Results are shown in the table below.

TABLE 1

| | | Comparative | | Comparative | | |
|---|---|---|---|---|---|---|
| | Example 1 | Example 1 | Example 2 | Example 2 | Example 3 | Example 4 |
| Plate | B | A | D | C | E | F |
| Friction | 0.055 | 0.125 | 0.045 | 0.12 | 0.033 | 0.029 |
| coefficient | | | | | | |
| Depth | 0 | 0.9 | 0 | 0 | 0 | 0 |
| of wear | | | | | | |
| [μm] | | | | | | |

Example 1 and Comparative Example 1 used the same test piece made of SUJ2 steel, wherein the surface of plate B in the former is covered with carboxyl groups derived from thioglycolic acid. Comparison of the surfaces of plates A and B after the sliding based on reflection-type, FT-IR spectra of plate B clearly showed peaks attributed to melamine N—H (3351 cm⁻¹), C—H stretching (2937 cm⁻¹, 2857 cm⁻¹) of long-chain alkyl group and ester carbonyl (1754 cm⁻¹), which are included in DM-2 in the lubricant. This suggests DM-2 segregated at the surface of plate B. It can be said that this is one of factors capable of achieving small friction coefficient and good anti-wearing property.

Example 2 and Comparative Example 2 used the same test piece made of SUJ2 steel covered with diamond-like carbon, wherein plate D in the former has carboxyl groups on the surface thereof introduced by oxygen plasma treatment. Comparison of the surfaces of plates C and D after the sliding based on reflection-type, FT-IR spectra of plate D clearly showed peaks attributed to melamine N—H (3351 cm⁻¹), and C—H stretching (2937 cm⁻¹, 2857 cm⁻¹) of long-chain alkyl group and ester carbonyl (1754 cm⁻¹), which are included in DM-2 in the lubricant. This suggests DM-2 segregated at the surface of plate B. It can be said that this is one of factors capable of achieving small friction coefficient and good anti-wearing property.

Example 3 and Example 4 used plates E and F both having hydrogen-bondable residues capable of forming a complex with DM-2, introduced by chemical modification of the surface of the diamond-like carbon film. Comparison of the surfaces of plates E and F after the sliding based on reflection-type, FT-IR spectra of both plates clearly showed peaks attributed to melamine N—H (3351 cm⁻¹), and C—H stretching (2937 cm⁻¹, 2857 cm⁻¹) of long-chain alkyl group and ester carbonyl (1754 cm⁻¹), which are included in DM-2 in the lubricant. This suggests DM-2 segregated at the surfaces of the plates.

### Example Nos. 5 to 21 and Comparative Example Nos. 3 to 9

Various lubricant compositions were prepared by employing various exemplified compounds having a discotic structure therein in the same manner as Example Nos. 1 to 4; combining each of the compositions with any one of Plate A to F as shown in the following table; and, for such combinations, friction/wear tests were carried out under conditions same as the above. Results are shown in the table below.

TABLE 2

| Example/ | | | | |
|---|---|---|---|---|
| Comparative | | | Friction | Depth of wear |
| Example No. | Compound | Plate | coefficient | [μm] |
| Example 5 | DM-3 | E | 0.053 | 0 |
| Example 6 | DM-3 | F | 0.064 | 0 |
| Comparative | DM-3 | C | 0.165 | 0 |
| Example 3 | | | | |
| Example 7 | DM-5 | E | 0.062 | 0 |
| Example 8 | DM-10 | E | 0.053 | 0 |
| Comparative | DM-10 | C | 0.144 | 0 |
| Example 4 | | | | |
| Comparative | DM-10 | A | 0.078 | 2.3 |
| Example 5 | | | | |
| Example 9 | DM-15 | E | 0.063 | 0 |
| Example 10 | DM-18 | E | 0.046 | 0 |
| Example 11 | DM-18 | F | 0.042 | 0 |
| Comparative | DM-18 | C | 0.189 | 0 |
| Example 6 | | | | |
| Example 12 | DM-21 | D | 0.055 | 0 |
| Example 13 | DM-7 | E | 0.064 | 0 |
| Example 14 | DM-7 | F | 0.075 | 0 |
| Comparative | DM-7 | C | 0.144 | 0 |
| Example 7 | | | | |
| Example 15 | DM-8 | E | 0.034 | 0 |
| Example 16 | DM-8 | F | 0.035 | 0 |
| Comparative | DM-8 | C | 0.114 | 0 |
| Example 8 | | | | |
| Example 17 | DM-11 | E | 0.039 | 0 |
| Example 18 | DM-11 | F | 0.048 | 0 |
| Comparative | DM-11 | C | 0.137 | 0 |
| Example 9 | | | | |
| Example 19 | DM-20 | B | 0.042 | 0 |
| Example 20 | DM-23 | D | 0.088 | 0 |
| Example 21 | DM-24 | E | 0.067 | 0 |

1. A mechanical element comprising at least two surfaces movable at peripheral speeds differed from each other, and a lubricant composition disposed between said two surfaces, a surface of at least one said two surfaces having an organic residue having carboxyl group, sulfoxyl group, cyclic or non-cyclic carbamoyl group, cyclic or non-cyclic ureylene group, cyclic or non-cyclic sulfamoyl group, or cyclic or non-cyclic amidino group, and said lubricant composition comprising a discotic compound having at least one tautomeric group represented by a formula (1) below: 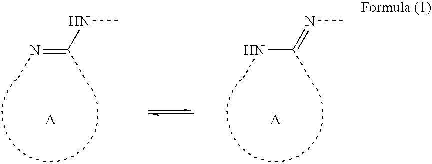
where, A is a ring in which from 5 to 7 atoms are embedded, wherein one of, or two or more of the ring-composing atoms may have a substituent, or may be condensed with other ring.

2. The mechanical element of claim 1, wherein the lubricant composition further comprises lubricating base oil.

3. The mechanical element of claim 1, wherein the lubricant composition comprises the discotic compound in an amount of from 0.1 to 30% with respect to the total mass.

4. The mechanical element of claim 1, wherein the discotic compound has at least three chain substituents each of which is five atoms or more bound to linearly.

5. The mechanical element of claim 1, wherein the discotic compound is represented by a formula (2) below: 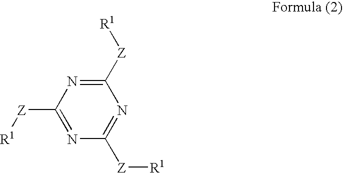
where, each of three Zs independently represents —O—, —S— or —NR— (R represents a hydrogen atom or C₁₀ or shorter alkyl group), provided that at least one of which represents —NH—; each of three R¹s independently represents a substituent, provided that at least two of which represent substituents each containing an aromatic ring group having a chain substituent which is five atoms or more bound to linearly.

6. The mechanical element of claim 1, wherein the discotic compound is a polymer represented by a formula (3)-a, (3)-b or (4) below: 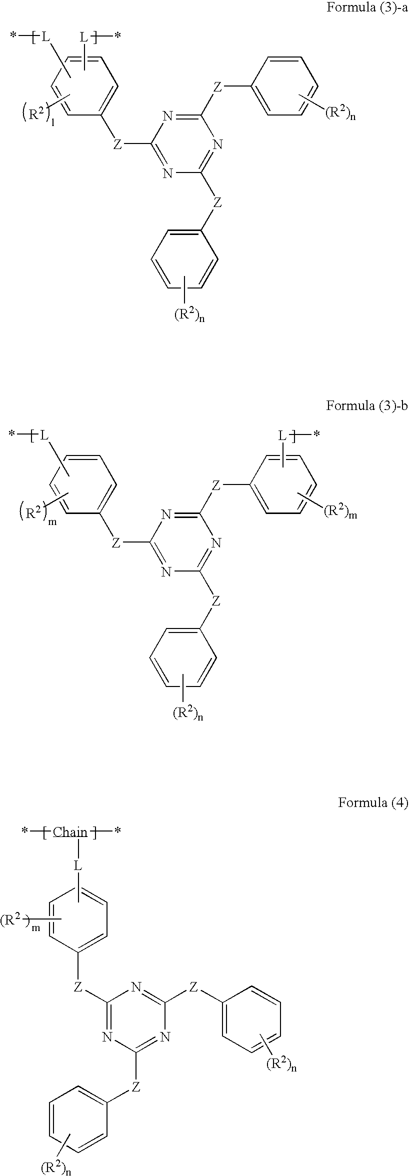
where, each of three Zs independently represents —O—, —S— or —NR— (R represents a hydrogen atom or C₁₀ or shorter alkyl group), provided that at least one of which represents —NH—; each of three R²s independently represents a substituent having the 80 or smaller number of atoms therein; I represents an integer from 0 to 3, m represents an integer from 0 to 4 and n represents an integer from 0 to 5, a plurality of ms and ns in the formulae may be same or different, a plurality of R²s, for the case where l, m and n are 2 or larger, may be same or different; each L independently represents a divalent linking group; and “Chain” represents a monomer-derived repeating unit composing the principal chain having at least L as a substituent.

7. The mechanical element of claim 6, wherein, in said formula (3)-a, formula (3)-b and formula (4), at least one of R²s represents a substituent having an oligoalkyleneoxy chain, oligosiloxy chain or oligoperfluoroalkyleneoxy chain therein.
